(19) United States
(12) Patent Application Publication
(10) Pub. No.: US 2023/0226512 A1
(43) Pub. Date: Jul. 20, 2023

(54) Production of Oxygen by the Reduction of Carbon Dioxide by Means of Induced Cavitation Generated by Submercco Plasma Arcs.

(71) Applicant: John H. BRYDEN, Lynden (CA)

(72) Inventor: John H. BRYDEN, Lynden (CA)

(21) Appl. No.: 17/300,999

(22) Filed: Jan. 18, 2022

(51) Int. Cl. B01J 19/00; C01B 13/02

(52) U.S. Cl. CPC B01J 19/008; C01B 13/0203

(57) ABSTRACT

This invention describes a novel method of obtaining life-sustaining quantities of oxygen by the reduction of carbon dioxide. It involves using submerged plasma arcs generated by high voltage capacitors to reduce carbon dioxide in water resulting in the production of oxygen and carbon. It promises to be a novel method for the production of large volumes of free oxygen capable of sustaining oxygen breathing life in extra terrestrial environments. Hence the use of the word “production” rather than “process” in the title.

### SUMMARY

This invention involves inducing cavitation in water by the submerged detonations of a plasma arcing device powered by a high voltage capacitor. Such devices are generally known as plasma sparkers.

The reduction of carbon dioxide by electrolysis is well known—a process which involves an anode and cathode submerged in an aqueous solution of carbon dioxide. The electrolysis process is slow however and has not been found to be commercially practical.

A plasma sparker can be thought of as a type of spark plug and in the context of this invention discharging in water or water vapor containing dissolved carbon dioxide. Obtaining oxygen by this means promises to be an efficient and cheap way of providing this vital gas to human installations on the planet Mars or other planets where carbon dioxide is an abundant gas in the atmosphere. Venus for example.

### DESCRIPTION

This application may be thought of as a companion to the nonprovisional application by this inventor entitled “Production of Carbon by Reducing Carbon Dioxide by Means of Induced Cavitation” Ser. No. 16/873,690 currently under examination. It is made practical and valuable by the fact that Mars is almost (but not quite) devoid of water but has an atmosphere that is 96% carbon dioxide. This means that oxygen and carbon can be readily produced by plasma sparkers powered by solar cells feeding high voltage capacitors. Plasma sparking devices are particularly appropriate for a remote and hostile environment since they have no moving parts to speak of save for electrodes which must be gradually replenished as they melt away during use.

There is prior art pertaining to the reduction of gaseous carbon dioxide by plasma arcing devices, but this does not involve cavitation which is currently understood to only occur in liquids.

See:

| | | |
|---|---|---|
| US 2011/0162958 A1 | Cho et al | 07 Jul. 2011 (07-07-2011) |
| US 2016/0221942 A1 | Morita | 04 Aug. 2016 (04-08-2016) |

Reducing carbon dioxide dissolved in water does not use up the water in the vessel containing the electrodes. The actual design of the plasma arcing devices is within the parameters of conventional engineering. Cavitation should be explained as a physical process that only received notice at the end of the last century and little scientific examination since. It is based on the observation that when water undergoes extreme physical stress while flowing by obstacles or around tight turns of pipes, high energy sparks occur that commonly cause the perforation of the hardest materials, hence the term cavitation. The currently accepted theory is that the sparks are caused by the collapse and implosion of vapor bubbles in the water. This explanation predates the development of nuclear physics in the first third of the 20th century.

This inventor looks to current atomic theory to postulate that the molecules of water and dissolved carbon dioxide if present are actually breaking when under extreme stress and changing the kinetic energy into heat and light. This explains the result of an experiment in which the author participated, whereby a closed container filled with carbonated water turned black when the fluid was subjected to the shock waves emanating from the submerged arcing of a plasma sparker. Subsequent literature research by the inventor has found the cavitation phenomenon to be ubiquitous in nature occurring in the vascular cells in plants, thunderstorms, and the wave action and deep ocean current flows, all of which involve the reduction of dissolved carbon dioxide to produce carbon and oxygen. See “Elucidations” attached to nonprovisional application “Production of Carbon by Reducing Carbon Dioxide by Means of Induced Cavitation” Ser. No. 16/873,690. ¹The devices envisioned for the use on Mars would each consist of a solar cell capacitor, 2 electrodes and a container, the latter either cylindrical or spherical, so that the shock waves from the arcing would rebound off the sides such that they would intersect with one another to produce multiple nodes of high energy sufficient to break the molecular bonds of water and carbon dioxide. ¹Further support for the authors nuclear explanation for cavitation is to be found by the causative logic that the eggs and pupae of black flies in swift flowing streams must be obtaining molecules of oxygen as a consequence of cavitation—see The Canadian Encyclopedia.

While the amount of oxygen produced by each device might be relatively modest there is theoretically no limit on the possible size of the array. The carbon by-product of this process and the heat generated by the plasma arcing can be piped out of the container and returned after suitable filtering and heat exchange. This means the original volume of water in the system can be largely contained. While water is scarce on Mars it is hoped that it can be obtained from the ice noted to exist on the planet in some areas; otherwise it would have to be brought from Earth.

1. The production of sustainable large quantities of free oxygen by the reduction of carbon dioxide dissolved in water induced by cavitation resulting from the shock waves emanating from the detonations of one or more submerged plasma arcing devices.
